(19) United States
(12) Patent Application Publication
(10) Pub. No.: US 2025/0184564 A1
(43) Pub. Date: Jun. 5, 2025

(54) METHOD, APPARATUS AND DEVICE FOR DISPLAYING INTERACTION INFORMATION

(71) Applicant: Beijing Zitiao Network Technology Co., Ltd., Haidian District, Beijing (CN)

(72) Inventor: Siyao Jin, Beijing (CN)

(21) Appl. No.: 18/864,697

(22) PCT Filed: Apr. 28, 2023
(86) PCT No.: PCT/CN2023/091896

§ 371 Date: Nov. 11, 2024

(30) Foreign Application Priority Data
May 10, 2022 (CN) 202210509553.4

(51) Int. Cl. H04N 21/431; H04N 21/2187; H04N 21/2743; H04N 21/4788

(52) U.S. Cl. CPC H04N 21/4316; H04N 21/2187; H04N 21/2743; H04N 21/4788

(57) ABSTRACT

There are provided a method, an apparatus, an electronic device, a computer readable storage medium, and a computer program product for displaying interaction information. In the method displaying a predetermined control in a relevant information display area or a target group of target content; in response to a triggering operation of the predetermined control, obtaining state information based on the triggering operation, the state information comprises information about whether a current user satisfies a predetermined condition and/or information about whether the current user is a predetermined state user, the predetermined state user being a user participating in a predetermined interaction event; and displaying the interaction information in the state information.

### CROSS REFERENCE TO RELATED APPLICATIONS

This application claims priority to Chinese Patent Application No. 202210509553.4, filed with the Chinese Patent Office on May 10, 2022, and entitled “METHOD, APPARATUS AND DEVICE FOR DISPLAYING INTERACTION INFORMATION”, which is incorporated herein by reference in its entirety.

### FIELD

Embodiments of the present disclosure relate to the field of computer technology, and in particular, to a method and an apparatus, an electronic device, a computer readable storage medium, and a computer program product for displaying interaction information.

### BACKGROUND

Currently, a user may share a captured video or photo on an Internet platform, and may also interact with other users on the Internet platform to share working content or life experience.

### SUMMARY

The embodiments of the present disclosure provide an interaction information display method and apparatus, an electronic device, a computer readable storage medium and a computer program product.

According to a first aspect, an embodiment of the present disclosure provides a method for displaying interaction information, including:
presenting a predetermined control within a relevant information display area of target content or a target group;
triggering, in response to a triggering operation on the predetermined control, to determine whether a current user satisfies a predetermined condition, and determining the current user satisfying the predetermined condition as a predetermined state user, the predetermined state user being a user participating in a predetermined interaction event;
obtaining state information based on the triggering operation, the state information comprising information about whether the current user satisfies the predetermined condition and/or information about whether the current user is the predetermined state user; and
displaying interaction information based on the state information, the interaction information being displayed based on the state information.

According to a second aspect, an embodiment of the present disclosure provides a method for displaying interaction information, including:
presenting a predetermined interaction event creating control in a predetermined function presenting area, the predetermined function presenting area being an interactive function presenting area of a relevant information display area of target content or an interactive function presenting area of a target group, and the target content being content posted by a current user; the target group being a group associated with the current user;
in response to a triggering operation on the predetermined interaction event creating control, presenting a predetermined information creating interface associated with the predetermined interaction event creating control, wherein the predetermined information creating interface comprises at least one condition setting control and a creation confirming control, and the condition setting control is configured for setting a predetermined condition for participating in a predetermined interaction event; and
in response to completing a setting operation for the predetermined condition, presenting a posting control, the posting control is configured for posting the predetermined interaction event.

According to a third aspect, an embodiment of the present disclosure provides an apparatus for displaying interaction information, including:
a presenting unit configured to present a predetermined control within a relevant information display area of target content or a target group;
a triggering unit configured to trigger, in response to a triggering operation of the predetermined control, to determine whether a current user satisfies a predetermined condition, and determine the current user satisfying the predetermined condition as a predetermined state user, the predetermined state user being a user participating in a predetermined interaction event;
an obtaining unit configured to obtain state information based on the triggering operation, the state information comprising information about whether the current user satisfies the predetermined condition and/or information about whether the current user is the predetermined state user; and
a displaying unit configured to display interaction information based on the state information, the interaction information being displayed based on the state information.

According to a fourth aspect, an embodiment of the present disclosure provides an apparatus for creating interaction information, including:
a presenting unit configured to present a predetermined interaction event creating control in a predetermined function presenting area, the predetermined function presenting area being an interactive function presenting area of a relevant information display area of target content or an interactive function presenting area of a target group, and the target content being content posted by a current user; the target group being a group associated with the current user;
a triggering unit configured to present, in response to a triggering operation on the predetermined interaction event creating control, a predetermined information creating interface associated with the predetermined interaction event creating control, wherein the predetermined information creating interface comprises at least one condition setting control and a creation confirming control, and the condition setting control is configured for setting a predetermined condition for participating in a predetermined interaction event; and
a posting unit configured to present a posting control in response to completing a setting operation for the predetermined condition, wherein the posting control is configured for posting the predetermined interaction event.

According to a fifth aspect, an embodiment of the present disclosure provides an electronic device, including: a processor and a memory;
the memory stores a computer execution instruction;
the processor executes the computer execution instruction stored in the memory, so that the at least one processor implements the method for displaying interaction information according to the first aspect and various possible designs according to the first aspect, or a method for creating interaction information according to the second aspect and various possible designs according to the second aspect.

According to a sixth aspect, an embodiment of the present disclosure provides a computer readable storage medium. The computer readable storage medium stores a computer execution instruction; when executing the computer execution instruction, a processor implements a method for displaying interaction information according to the first aspect and various possible designs of the first aspect, or the second aspect and various possible designs of the second aspect.

According to a seventh aspect, an embodiment of the present disclosure provides a computer program product, including a computer program. When being executed by a processor, the computer program implements a method for displaying interaction information according to the foregoing first aspect and various possible designs of the first aspect, or a method for creating interaction information according to the foregoing second aspect and various possible designs of the second aspect.

### BRIEF DESCRIPTION OF THE DRAWINGS

In order to more clearly illustrate the technical solutions in the embodiments of the present disclosures or prior art, the following will be a brief introduction to the accompanying drawings required for the description of the embodiments or the prior art. Obviously, the accompanying drawings in the following description relate to some embodiments of the present disclosure. For those of ordinary skill in the art, other drawings can be obtained according to these drawings without creative labor.

FIG. 1 is a schematic diagram of a system architecture of a method for displaying interaction information provided by an embodiment of the present disclosure.

FIG. 2 is schematic flowchart one of a method for displaying interaction information provided by an embodiment of the present disclosure.

FIG. 3 is a schematic diagram of presenting a predetermined control in a relevant information display area of target content provided by an embodiment of the present disclosure.

FIG. 4 is schematic diagram one of a presented interaction interface provided by an embodiment of the present disclosure.

FIG. 5 is schematic diagram two of a presented interaction interface provided by an embodiment of the present disclosure.

FIG. 6 is schematic diagram three of a presented interaction interface provided by an embodiment of the present disclosure.

FIG. 7 is schematic diagram three of a presented interaction interface provided by an embodiment of the present disclosure.

FIG. 8 is schematic flowchart two of a method for displaying interaction information provided by an embodiment of the present disclosure.

FIG. 9 is schematic diagram four of a presented interaction interface provided by an embodiment of the present disclosure.

FIG. 10 is schematic diagram five of a presented interaction interface provided by an embodiment of the present disclosure.

FIG. 11 is schematic diagram six of a presented interaction interface provided by an embodiment of the present disclosure.

FIG. 12 is schematic diagram seven of a presented interaction interface provided by an embodiment of the present disclosure.

FIG. 13 is schematic diagram eight of a presented interaction interface provided by an embodiment of the present disclosure.

FIG. 14 is schematic diagram nine of a presented interaction interface provided by an embodiment of the present disclosure.

FIG. 15 is schematic diagram ten of a presented interaction interface provided by an embodiment of the present disclosure.

FIG. 16 is schematic flowchart three of a method for displaying interaction information provided by an embodiment of the present disclosure.

FIG. 17 is schematic flowchart four of a method for displaying interaction information provided by an embodiment of the present disclosure.

FIG. 18 is a schematic diagram of a predetermined function presenting area provided by an embodiment of the present disclosure.

FIG. 19 is a schematic diagram of a predetermined information creating interface provided by an embodiment of the present disclosure.

FIG. 20 is a schematic diagram of a participation condition setting interface provided by an embodiment of the present disclosure.

FIG. 21 is a schematic diagram of activity information confirmation presenting confirming page provided by an embodiment of the present disclosure.

FIG. 22 is a structural block diagram of a display apparatus for interaction information according to an embodiment of the present disclosure.

FIG. 23 is a structural block diagram of a creation apparatus for interaction information according to an embodiment of the present disclosure.

FIG. 24 is a schematic structural diagram of an electronic device according to an embodiment of the present disclosure.

### DETAILED DESCRIPTION

In order to make objects, technical solutions and advantages of the embodiments of the present disclosure more apparent, the technical solutions in the embodiments of the present disclosure will be described below in a clearly and fully understandable way in connection with the drawings in the embodiments of the present disclosure. Obviously, the described embodiments are only a part but not all of the embodiments of the present disclosure. All other embodiments obtained by those skilled in the art based on the embodiments of the present disclosure without creative efforts shall belong to the scope of protection of the present disclosure.

An Internet platform provides a platform for a user to share working content or life experience. In order to increase the interaction frequency among users and improve user stickiness of the Internet platform, a component for completing a resource random allocation event is arranged in the Internet platform, so that the user can participate in the resource random allocation event, thereby enhancing the experience in using the Internet platform. However, details and the participation ways of participating in the initiated resource random allocation event are usually displayed on a home page of an author who shares content, which causes other users not able to learn about the situation and participation ways of the relevant activities in time, and thus affecting user experience in using the Internet platform.

Therefore, the embodiments of the present application provide a method for displaying interaction information. By providing, in a comment of a shared video, another control for participating in a resource random allocation interaction event, or displaying the control for participating in the resource random allocation interaction event within a user group having a higher interaction frequency, other users can more easily obtain interaction information for participating in the resource random allocation event, and thus participate in related interaction activities in time, which improves user experience in using the internet platform.

For example, the displaying method for interaction information provided in the embodiments of the present disclosure may be applied to the system as shown in FIG. 1. The system architecture includes a terminal 101 and a server 102, where the terminal 101 and the server 102 may be communicatively connected through a network 103. The terminal 101 is a terminal device, and the terminal device involved in the present disclosure may be a wireless terminal or a wired terminal. The wireless terminal may refer to a device that provides voice and/or other service data connectivity to a user, a handheld device having a wireless connection function, or another processing device connected to a wireless modem. A wireless terminal may communicate with one or more core network devices via a radio access network (RAN). The wireless terminal may be a mobile terminal, such as a mobile phone (or referred to as a “cellular” phone) and a computer having the mobile terminal, for example, it may be a portable, pocket-sized, handheld, computer built-in, or vehicle-mounted mobile apparatus, which exchanges a language and/or data with the radio access network. For another example, the wireless terminal may also be a device such as a Personal Communication Service (PCS for short) phone, a cordless phone, a Session Initiation Protocol (SIP for short) phone, a Wireless Local Loop (WLL for short) station, or a Personal Digital Assistant (PDA for short). The wireless terminal may also be referred to as a system, a subscriber unit, a subscriber station, a mobile station, a remote station, a remote terminal, an access terminal, a user terminal, a user agent, or a user device or user equipment, which is not limited herein. Optionally, the terminal device may also be a device such as a smart watch or a tablet computer, and the server 102 is a server or a cluster constituted of a plurality of servers.

Optionally, the method for displaying interaction information provided in the embodiment of the present application may be applied to the terminal 101 shown in FIG. 1. As shown in FIG. 1, in a client of a terminal 101 used by a user who initiates an interaction event, a control for other users to participate in a resource random allocation event is presented in a relevant display area of a shared content, in a client where another user uses the terminal 101, participation may be implemented through a control corresponding to the resource random allocation event and being displayed in the relevant display area. The server 102 randomly allocates the resources to be allocated to all users participating in the resource random allocation event, to determine information about all the participating users who have successfully obtained the resources to be allocated, and transmits user information about all the users successfully participating in the event to a client of the terminal 101 used by the user who initiates the interaction event, and present an activity result of the resource random allocation event.

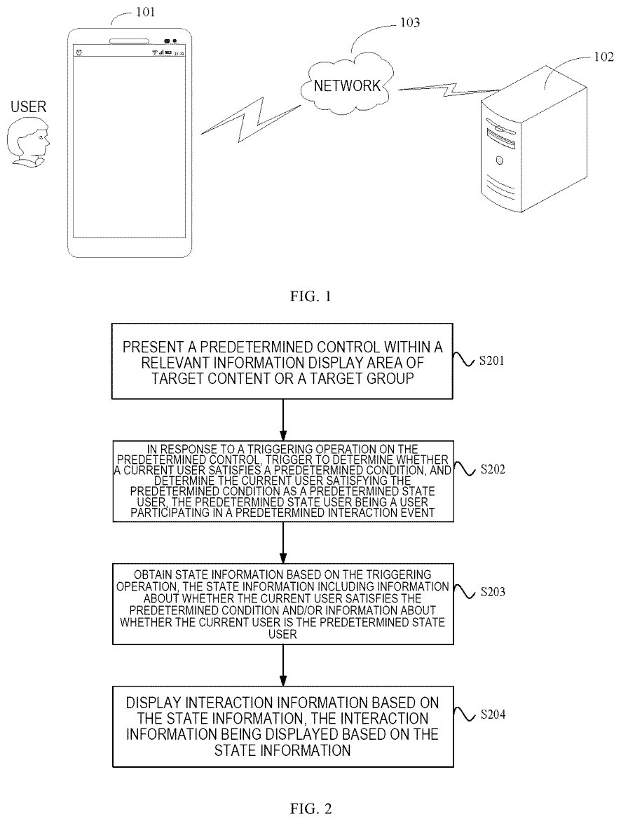

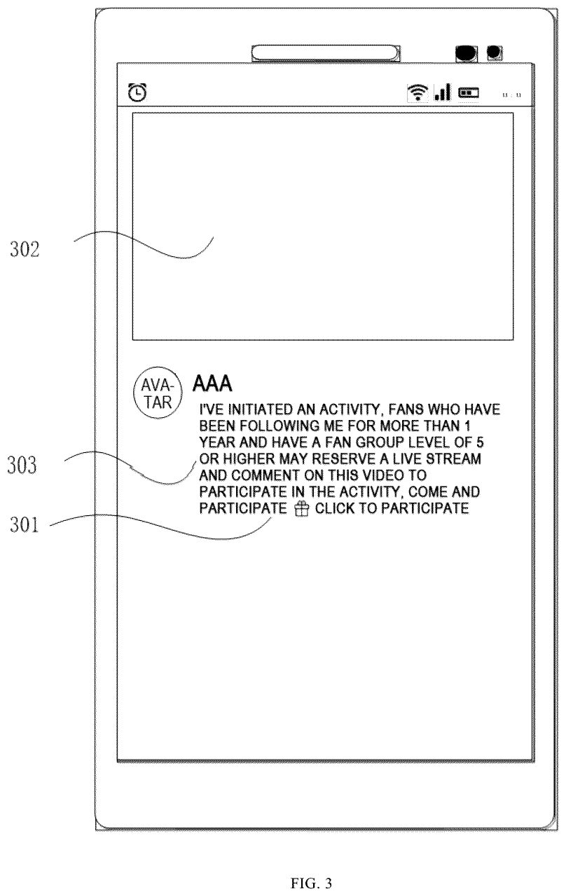

Referring to FIG. 2, FIG. 2 is a schematic flowchart one of a method for displaying interaction information according to an embodiment of the present disclosure. The method in this embodiment may be applied to a terminal. The method for displaying interaction information includes:

S201: presenting a predetermined control within a relevant information display area of target content or a target group.

In this embodiment, all users may upload to-be-shared videos or other content as target content in the terminal application software. In order to improve the propagation effect of target content shared by a user, a predetermined control corresponding to a resource random allocation event may be displayed in a relevant comment in a comment area below the shared target content, so that other users browsing the target content can select the predetermined control in the comment area of the video to participate in the resource random allocation event corresponding to a predetermined interaction event. For example, the relevant information display area of the target content is the comment area of the target content, for example, for a first comment displayed in the comment area, a predetermined control corresponding to the resource random allocation event may be displayed in the first comment displayed in the target content. For example, relevant content of the predetermined control is further displayed in the title of the target content, so as to prompt the user that he/she may view and participate in the resource allocation event by opening the comment area of the target content.

For example, a user who shares target content may further present a predetermined control corresponding to a predetermined interaction event in a target group, so that other users may participate in a resource random allocation event corresponding to the predetermined interaction event by selecting the predetermined control corresponding to the predetermined interaction event in a chat group. The target group is a group associated with the current user, and specifically, the target group may be a group of any platform of user components that shares the target content. For example, a predetermined control is displayed in a chat group in the form of a forwarding topic, and relevant information of resources included in the predetermined interaction event and related specific content about participating in a resource random allocation activity are displayed in the forwarding topic.

In one embodiment of the present disclosure, the predetermined control may be a predetermined graphical button. FIG. 3 is a schematic diagram of presenting the predetermined control in the relevant information display area of the target content provided by an embodiment of the present disclosure. For example, the predetermined graphical button corresponding to the predetermined control 301 is located in the relevant information display area 303 of the target content 302, that is, in the first pinned comment. The first pinned comment of the target content 302 further includes relevant content of resource random allocation corresponding to the predetermined interaction event, for example, content such as a participation manner, name of an allocated resource product, and a quota of participation. Exemplarily, a graphic of the participation button corresponding to the predetermined control 301 may be a circle, a square, a triangle, or any other graphic, and a color of the graphic of the participation button is inconsistent with a color of a font displayed in the comment area. As shown in FIG. 3, the participation button corresponding to the predetermined control 301 is displayed in a blue pattern in a gift style, or other colors different from colors of the presented comment fonts, so that the user can conveniently observe the predetermined control 301 corresponding to participation of the random resource allocation event.

S202: triggering, in response to a triggering operation on the predetermined control, to determine whether a current user satisfies a predetermined condition, and determining the current user satisfying the predetermined condition as a predetermined state user, the predetermined state user being a user participating in a predetermined interaction event.

In this embodiment, the triggering operation may be a user touch operation, or a user selection through a key or a user click operation through a mouse.

In the embodiment shown in FIG. 3, when a user selects the predetermined control 301, in response to the triggering operation on the predetermined control 301, the current user is set as a predetermined state user who is determined to participate in the predetermined interaction event, that is, it is determined that the user participates in the resource random allocation event initiated by a user who shares a video. Specifically, an identifier corresponding to the predetermined interaction event is added to a user identifier of the predetermined state user, so as to represent that the current user is a user participating in the predetermined interaction event. The predetermined interaction event is a random resource allocation event. Specifically, a result of the predetermined interaction event is a result of randomly allocating predetermined resources corresponding to the predetermined interaction event to at least one target user in the predetermined state users.

In an embodiment of the present disclosure, in response to the triggering operation on the predetermined control 301, the terminal may also transmit user identifiers of all users who click the predetermined control 301 to the background server of the Internet platform, so that the background server sets all users participating in the predetermined interaction event as the predetermined state users, and transmits information of all predetermined state users to the client of the terminal.

S203: obtaining state information based on the triggering operation, wherein the state information includes information about whether the current user satisfies the predetermined condition and/or information about whether the current user is the predetermined state user.

In this embodiment, after it is determined that the current user performs a triggering operation on the predetermined control 301, in order to determine whether the current user qualifies to participate in the resource random allocation event, state information of the user may be obtained.

In one embodiment of the present disclosure, the state information includes a predetermined condition about whether the current user satisfies the predetermined condition and the result indicating whether the current user is the predetermined state user. Exemplarily, when a user meets a predetermined condition for participating in the predetermined interaction event, information in the state information indicating whether the current user meets the predetermined condition is a predetermined coincidence identifier. Exemplarily, when the current user is a predetermined state user, information in the state information indicating whether the current user is a predetermined state user is set to be a predetermined state user identifier.

In this embodiment, the difference from a manner in the prior art for participating in the resource random allocation event are that, in the prior art, generally only participation conditions for a user to participate in a resource random allocation event (such as forwarding content and comment content) are set, whereas, in this embodiment, all users triggering the predetermined control 301 are set as predetermined state users, and only a predetermined state user satisfying a predetermined participation condition corresponding to a predetermined interaction event may participate in the relevant resource random allocation event. A predetermined state user is a user who approves the target content 302 and performs a specific participation action. Compared with the prior art, a predetermined state user is a target population for a user who initiates a predetermined interaction event. In this embodiment, by initiating the random resource allocation event in the target group, the publicity effect of the target content 302 and the activity effect of the initiated random resource allocation event may be correspondingly improved.

S204: displaying interaction information based on the state information, the interaction information being displayed based on the state information.

In this embodiment, different interaction information is presented based on state information of different users. For example, in S203, the state information includes information about whether the current user satisfies the predetermined condition and/or information about whether the current user is a predetermined state user, that is, different interaction information is presented to the user according to results of information about whether different users satisfy the predetermined condition and information about whether the different users are predetermined state users.

In an embodiment of the present disclosure, an interaction interface is presented based on state information of a current user. Exemplarily, the interaction interface includes interaction information, and specifically, the interaction information includes at least one piece of state presentation information and/or at least one interaction control. In this embodiment, according to results of information about whether a user satisfies the predetermined condition and information about whether the user is a predetermined state user, an interaction interface containing at least one piece of state presentation information and at least one interaction control is presented to the user, and the user can participate in the predetermined interaction event via the presented interaction control. Exemplarily, the interaction control is a button for a predetermined interaction operation, and the predetermined interaction operation is set by a user who initiates a resource allocation event.

It can be seen from the above description that, a control for participating in the resource random event is displayed in the comment area of the shared content, so that a user can directly participate in the predetermined interaction event by clicking the presented predetermined control when browsing the content, so that the user can easily obtain interaction information for participating in the resource random allocation event and participate in relevant interaction activities in time, which improves user experience in using the Internet platform.

In one embodiment of the present disclosure, the state presentation information includes first state presentation information and/or second state presentation information. Specifically, the first state presentation information is configured for indicating whether a user is a predetermined state user, and through the first state presentation information, it is displayed that the current user is a predetermined user, i.e., the current user is a participating user who participates in a resource random event. Specifically, the second state presentation information is configured for indicating whether a user satisfies a predetermined condition, and through the second state presentation information, whether a current user satisfies a participation condition for participating in the resource random allocation event is displayed. Exemplarily, the predetermined condition includes at least one participation condition, and specifically, the participation condition includes whether the user belongs to a predetermined user set. The predetermined user set is a feature of the participating group set by a user who initiates a predetermined interaction event. Exemplarily, the predetermined user set, i.e., the set feature of the participating group, may contain conditions such as the following time when a user following the user who initiates the resource random allocation event (i.e., the author), whether a user is a follower of the author or whether the number of interactions with the author is equal.

It can be seen from the above description that, by setting a predetermined user set, the user who initiates a random resource allocation event can set object features of time for participating in the random resource allocation event, so as to improve the publicity effect of the target content.

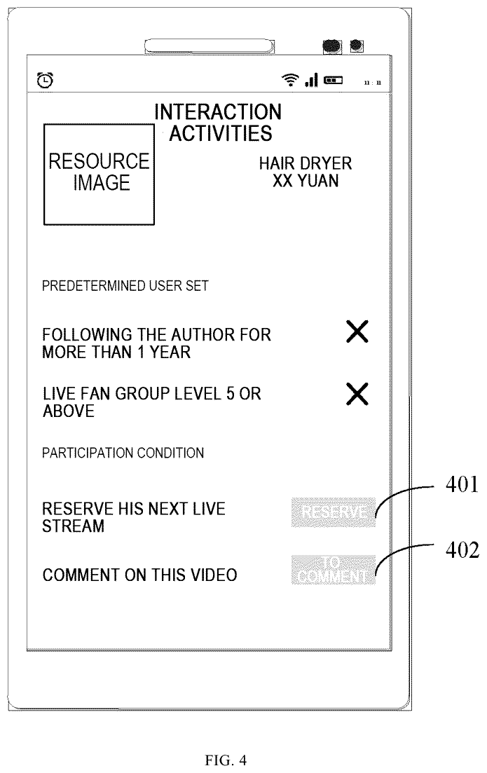

In one embodiment of the present disclosure, a target presentation mode for at least one interaction control is determined based on the state information, and the at least one interaction control is presented in a corresponding target presentation mode. Exemplarily, in response to determining based on the state information that the current user does not satisfy at least one participation condition in the predetermined conditions, the target presentation mode is determined as the first presentation mode. Specifically, the first presentation mode of the interaction control is setting gray or setting to be non-triggerable. FIG. 4 is a schematic diagram of a presented interaction interface provided by an embodiment of the present disclosure. Exemplarily, as shown in FIG. 4, a condition in the participation condition set by a predetermined user set is “following the author for more than one year” and “live fan group above level 5”, the interaction control includes an “Reserve” interaction control 401 corresponding to “Reserve his next livestream”, and a “To comment” interaction control 402 corresponding to “Comment on this video”. When it is determined, according to the state information of the current user, that the user does not satisfies the participation condition, that is, the user is not a user following the author more than 1 year, or the user is not a user of live fan group above level 5, or the user does not belong to the two predetermined user sets, the buttons for the “Reserve” interaction control component 401 and the “To comment” interaction control component 402 are set as gray or set to be non-triggerable. Exemplarily, a reason why the user cannot participate in the predetermined interaction event is displayed in the displayed interaction interface, for example, a floating prompt phrase “The participation range is not met and participation is impossible” is displayed. The title displayed in the displayed interaction interface is “Interaction activity”, and a situation of resources corresponding to the resource random allocation event, such as the name and product value of the product, is displayed below the title.

In one embodiment of the present disclosure, the predetermined condition further comprises at least one interaction condition. Exemplarily, in a process of determining the presentation mode for the interaction control, in response to determining, based on the state information, that the current user satisfies all the participation conditions in the predetermined condition, a target presentation mode for the at least one interaction control is determined based on the at least one interaction condition. Specifically, when it is determined, according to the state information of the current user, that the current user satisfies the participation condition in the predetermined condition, that is, the current user belongs to a predetermined user set, then, the state information of the current user is determined, that is, it is determined whether an interaction condition in the predetermined condition is satisfied, and the interaction control is displayed according to the determination result.

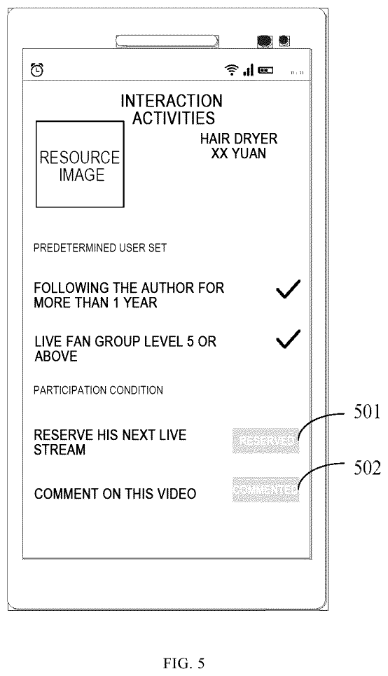

In an example, in response to determining, based on the state information, that the current user satisfies a first interaction condition in the predetermined condition, a target presentation mode for the first interaction control corresponding to the first interaction condition is determined as a second presentation mode. Specifically, the first interaction condition is whether the user has commented on this video and whether the next livestream is reserved. FIG. 5 is a schematic diagram two of presented interaction interface according to an embodiment of the present disclosure. Exemplarily, as shown in FIG. 5, the first interaction control includes a “Reserve” interaction control 501 corresponding to “Reserve his next livestream”, and a “Commented” interaction control 502 corresponding to “Comment on this video”. When it is confirmed, according to the state information of the user, that the current user belongs to users “Following the author more than 1 year” and users who belongs to the “Live fan group above level 5”, or when it is determined, according to state information of the current user, that the current user satisfies a first interaction condition in the predetermined condition, that is, when the current user has commented on this video and has reserved the next livestream, the “Reserved” interaction control 501 and the “Commented” interaction control 502 in the first interaction control are displayed as grayed or set to be non-triggerable. Exemplarily, a participation state of the user may be displayed in the displayed interaction interface, for example, a floating prompt phrase “Thanks for your participation” is displayed.

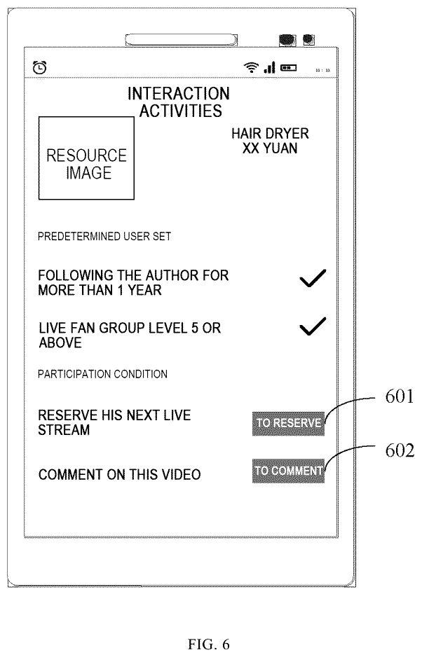

In one embodiment of the present disclosure, in response to determining, based on the state information, that the current user does not satisfy a second interaction condition in the predetermined condition, a target presentation mode for a second interaction control corresponding to the second interaction condition is determined as a third presentation mode. The second interaction condition is whether or not the user has commented the video and whether or not the user has reserved the next livestream. The second interaction control is a to-comment button or a reservation button, or the second interaction control includes the to-comment button or the reservation button. The specific setting of the second interaction control is set by the user who initiates the resource allocation event. FIG. 6 is a schematic diagram three of a presented interaction interface according to an embodiment of the present disclosure. Exemplarily, as shown in FIG. 6, the second interaction control includes a “Reserve” interaction control 601 corresponding to “Reserve his next livestream”, and a “To comment” interaction control 602 corresponding to “Comment on this video”. When it is confirmed, according to the state information of the user, that the current user belongs to users “Following the author more than 1 year” and users who belongs to the “Live fan group above level 5”, and when it is determined, according to state information about a current user, that the current user does not satisfy a second interaction condition in the predetermined condition, that is, when the user has not commented on this video, the “To comment” interaction control 602 is in a triggerable state, or when the user has not reserved the next livestream, the “To comment” interaction control 601 is in a triggerable state. Exemplarily, a user participation result is displayed in the displayed interaction interface, for example, a floating prompt phrase “The participation condition is not met, please make a reservation and comment′. When a user clicks the “Reserve” button, a home page announcement of the user who initiates a predetermined interaction event is obtained, and a control for reserving a livestream is selected. When the user clicks the “To comment” button, a comment interface of the user who initiates the predetermined interaction event is obtained and presented.

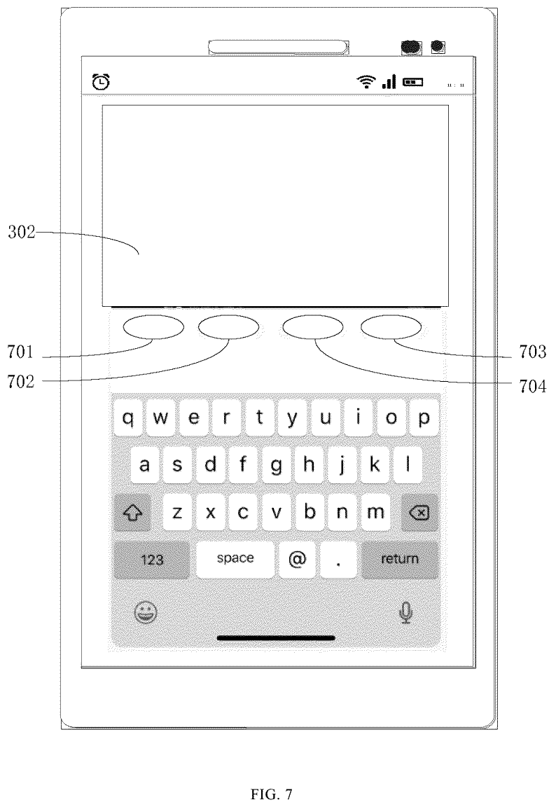

For example, in a case that the target presentation mode for the second interaction control is the third presentation mode, in response to a triggering operation on the second interaction control, an interaction page associated with the second interaction condition is displayed. Specifically, after the user clicks the “To comment” interaction control 602, the interaction page associated with the second interaction condition is displayed, that is, an interface for commenting on the target content is jumped to. Specifically, the interaction page includes at least one third interaction control, wherein the third interaction control is configured for performing an interaction operation of a predetermined type corresponding to the second interaction control, and the third interaction control is a comment inputting control. FIG. 7 is a schematic diagram three of a presented interaction page according to an embodiment of the present disclosure. As shown in FIG. 7, four third interaction controls are displayed in the interaction page, that is, a first comment input control 401, a second comment input control 402, a third comment input control 403 and a fourth comment input control 404 are displayed in the interaction page. The user may directly click the first input comment control 401, the second input comment control 402, the third input comment control 403, and the fourth input comment control 404 to display corresponding comment content in a comment area for the target content 302. Exemplarily, after the user comments, prompt words “Activity result will be sent to you by a small assistant in a form of internal email, please check and fill in an address in time′ will be displayed, and the prompt words disappear after 5 seconds.

In an embodiment of the present disclosure, the at least one piece of state presentation information further includes third state presentation information, the predetermined condition further comprises a predetermined time limit condition, and the third state presentation information is further configured for indicating whether a triggering operation on the predetermined control satisfies the predetermined time limit condition. Specifically, a predetermined time limit condition is an activity end time point set by a user who initiate the resource random allocation event, and when the activity end time point is exceeded, it is prompted that the activity time has been exceeded, and participation in the interaction activity is not allowed. Exemplarily, in response to determining, based on the state information, that the triggering operation on the predetermined control does not satisfy the predetermined time limit condition, the target presentation mode for the third interaction control corresponding to the predetermined time limit condition is determined as a fourth presentation mode. Specifically, according to a time point when a user clicks the predetermined control, whether a predetermined time limit condition is satisfied is determined, i.e., whether it is before the activity end time point is determined, and if the predetermined time limit condition is not satisfied, a fourth interaction control button is set as grey or as non-clickable. The fourth interaction control button is “Activity is ended”.

It can be seen from the above description that, according to state information of different users, an interactive interface presented to the users is set and interaction interfaces in different states are presented, which provides an interactive interface method for displaying different users participating in a predetermined interaction event, thereby improving the operation experience of the users.

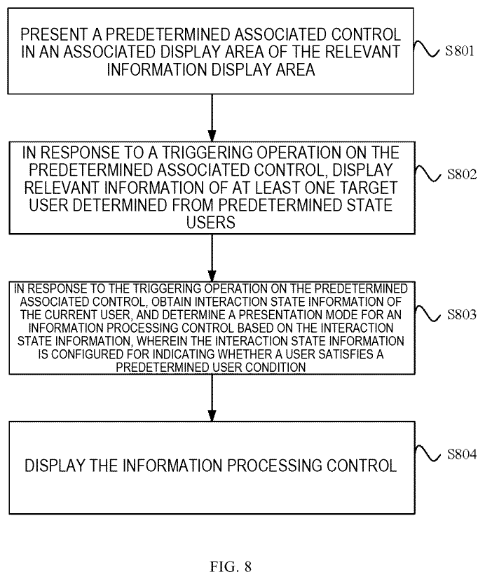

Referring to FIG. 8, FIG. 8 is a schematic flowchart two of a method for displaying interaction information according to an embodiment of the present disclosure. In this embodiment, a process of learning a result of resource random allocation after a user participates in a predetermined interaction event is described in detail. The method for displaying interaction information comprises:

S801: presenting a predetermined associated control in an associated display area of the relevant information display area.

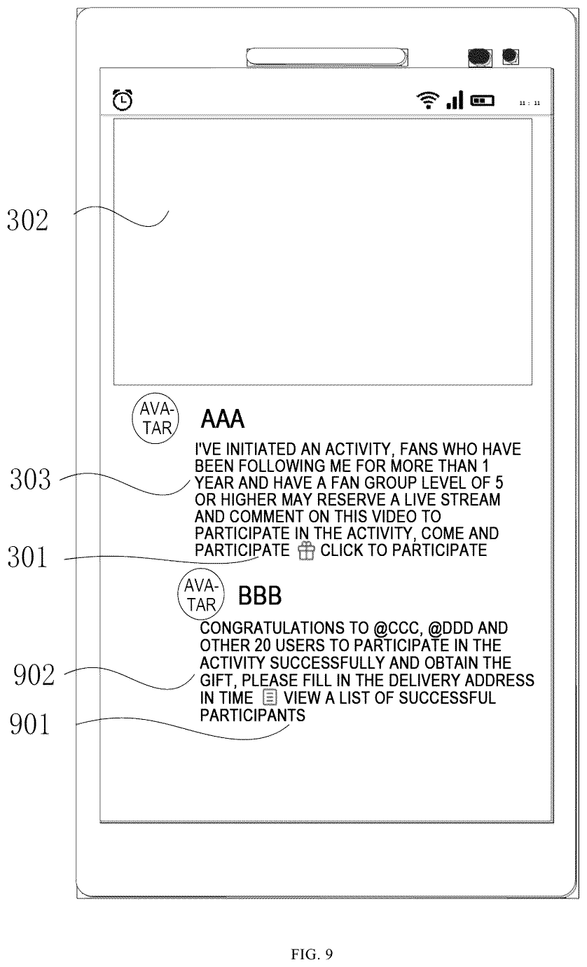

In this embodiment, the relevant information display area is the relevant information display area 303 of the target content 302 in the embodiment shown in FIG. 2. For example, referring to FIG. 9, the relevant information display area 303 of the target content 302 in FIG. 9 is the first pinned comment of the target content 302, and the associated display area 902 of the relevant information display area is the first reply comment in reply to the first pinned comment. Exemplarily, the predetermined associated control 901 is displayed at the end of the first reply comment in reply to the first pinned comment. Specifically, the first reply comment in reply to the first pinned comment also includes relevant information of at least one target user. Specifically, the participation button corresponding to the predetermined associated control 901 is a graphic in a specific color, so that the user can conveniently view the participation button corresponding to the predetermined associated control, thereby improving participation of the user participating in activities related to the Internet platform.

S802: in response to a triggering operation on the predetermined associated control, displaying relevant information of at least one target user determined from the predetermined state users.

In this embodiment, the result of the predetermined interaction event is a result of randomly allocating predetermined resources corresponding to the predetermined interaction event to at least one target in the predetermined state users.

In the embodiment shown in FIG. 9, in response to a triggering operation on the predetermined associated control 901 executed by the user, relevant information of at least one target user is displayed in a floating manner. Exemplarily, the target user is a user who participates in a predetermined interaction event and obtains randomly allocated resources. Specifically, a result of the target user is randomly determined by a background server corresponding to an Internet platform.

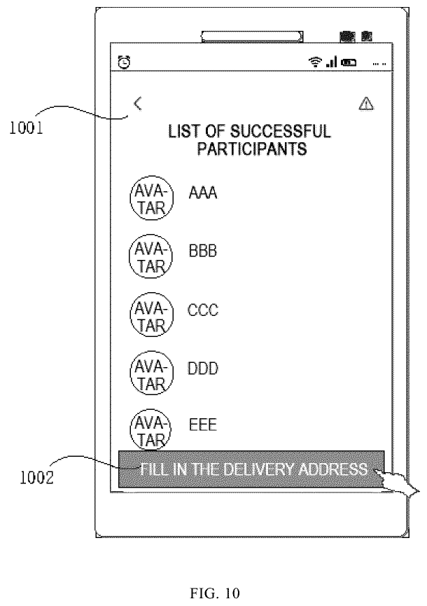

In this embodiment, as shown in FIG. 10, account information of all target users that obtain randomly allocated resources is displayed in a floating manner. Exemplarily, account information of a target user is displayed in the form of a participation success page 1001. The subject of the participation success page 1001 is a participation success list, and the list contains account names and account avatars of all target users. Specifically, the participation success page 1001 is further displayed with a resource image to prompt that the user has successfully obtained the allocated resources.

S803: in response to the triggering operation on the predetermined associated control, obtaining interaction state information of the current user, and determining a presentation mode for an information processing control based on the interaction state information, wherein the interaction state information is configured for indicating whether a user satisfies a predetermined user condition.

In this embodiment, the user interaction state information includes results of all interaction events that the current user participates in, and results of successful participants for all the interaction events initiated by the current user.

For example, functions of information processing controls corresponding to different user conditions are different, and the presentation modes thereof are also different. The predetermined user condition includes a target user condition, and the information processing control includes an information input control. The user corresponding to the target user condition is a user who has successfully obtained resources, and the information input control is a control provided to the target user for inputting a delivery address. Optionally, the predetermined user condition further includes an initiating user condition, and the information processing control further includes an information querying control. Specifically, the user corresponding to the initiating user condition is a user who initiates a predetermined interaction event, and the information querying control is a control for providing the initiating user to view the delivery address of the target user.

S804: displaying the information processing control.

In one embodiment of the present disclosure, for example, the predetermined user condition includes a target user condition, and the information processing control includes an information input control. Specifically, if it is determined, based on the interaction state information, that the current user satisfies the target user condition, the information input control is presented; in response to a triggering operation on the information input control, an information input interface is presented, and the information input control is configured for being provided to the current user satisfying the target user condition for information input.

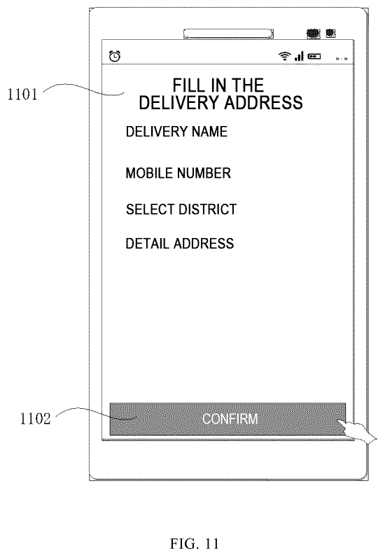

For example, as shown in FIG. 10, a button for the information input control 1002 is displayed in a highlighted form below the participation success page 1001. Specifically, the name of the information input control 1002 is “Filling in delivery address”. As shown in FIG. 11, the information input interface 1101 is an interface display in a floating manner, and the title of the information input interface 1101 is “Filling in delivery address”. The information input interface 1101 includes at least one information input box. Specifically, the input box included in the information input interface 1101 includes a delivery name, a mobile phone number, a selection for district and detailed address. The information input interface 1101 further includes a predetermined confirmation control 1102. Specifically, prompt words presented by the predetermined confirmation control 1102 is “OK”.

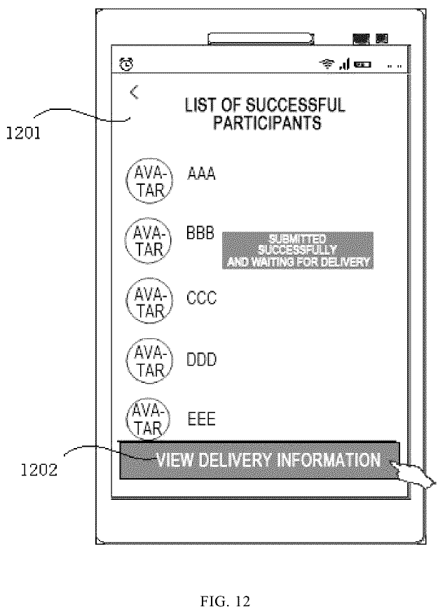

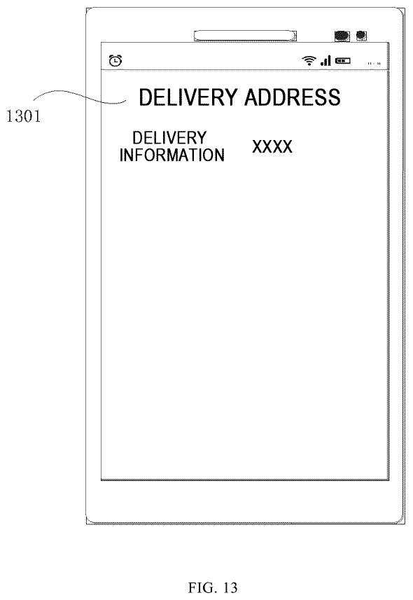

In one embodiment of the present disclosure, in response to a triggering operation on a predetermined confirmation control 1102 of an information input interface 1101, a view association interface of the predetermined confirmation control 1102 is displayed, and in response to a triggering operation on a view information control of the view association interface, a predetermined associated page of the predetermined confirmation control is displayed, where the predetermined associated page includes association information submitted by the current user on the information input interface. Exemplarily, as shown in FIG. 12, the view association interface 1201 is an interface displayed in a floating manner, and the view association interface 1201 is displayed with the prompt words “Successful submission” in a floating manner. Specifically, the presentation content of the view information control 1202 is “View delivery information”. Exemplarily, when the user clicks “View delivery information” on the view association interface 1201, it is jumped from the current page to the predetermined associated page corresponding to the view information control 1202. As shown in FIG. 13, a predetermined association page 1301 of the view information control 1202 is displayed, and the predetermined association page 1301 includes specific information submitted by the current user in the information input interface 1101.

It can be seen from the above description that when a target user views a list of successful participants, it is directly jumped to an information input interface for inputting a delivery address by clicking an information input control, thereby improving the user experience.

In one embodiment of the present disclosure, the predetermined user condition includes an initiating user condition, a user corresponding to the initiating user condition is a user who posts a predetermined activity. The information processing control includes an information querying control, the current user is determined as satisfying the initiating user condition based on the interaction state information, and the information querying control is presented.

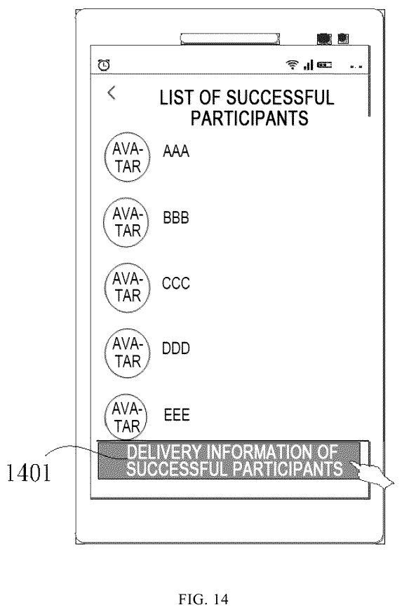

In this embodiment, the predetermined user may obtain, by clicking the predetermined associated control, a list of all the users who have successfully obtained the randomly allocated resources, so as to subsequently dispatch the allocated resources corresponding to the predetermined interaction event according to the list. As shown in FIG. 14, a button of the information querying control 1401 is displayed in a highlighted form at the bottom of the participation success page. Specifically, the name of the information querying control 1401 is “Obtaining delivery information of a resource user′.

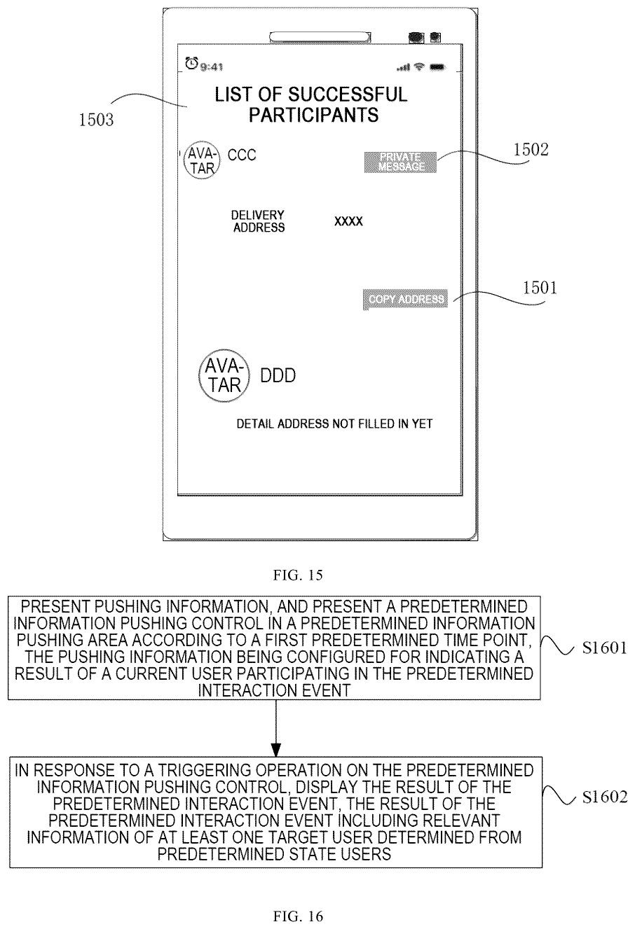

In this embodiment, in response to a triggering operation on the information querying control, an information collection interface is presented, the information collection interface including at least one of the following: association information corresponding to the at least one target user, an information collection control corresponding to the at least one target user and an information interactive control corresponding to the at least one target user. Exemplarily, in response to a triggering operation on the information collection control corresponding to the target user, the association information corresponding to the target user is obtained; and/or, in response to a triggering operation on the information interactive control corresponding to the target user, an information interactive interface corresponding to the target user is presented. In this embodiment, as shown in FIG. 15, when the target user has filled in the delivery address information, the corresponding association information is the delivery address information of the target user; and when the target user has not filled in the delivery address information, the corresponding association information is that the address is not filled. The button of the information collection control 1501 displayed in the information collection interface 1503 is “Copy address”, and the button of the information interactive control 1502 corresponding to the target user is “private message”. When the user clicks the information interactive control 1502, the user may communicate with the target user in a chat interface provided by the Internet platform.

It can be seen from the above description that when a user initiating a predetermined interaction event views a list of successful participants, an interface displaying a delivery address is jumped to by clicking the information querying control, and by providing the information collection control and an information interactive control, the initiating user can directly copy the delivery address and chat with a target user, thereby improving the user experience.

In one embodiment of the present disclosure, after obtaining prompt information for inputting address, a terminal of the target user presents an input address prompt control in a predetermined information pushing area, wherein the input address prompt information is configured for instructing an initiating user to input address time limit within a time limit for address input. Exemplarily, the predetermined information pushing area is an intra-station information pushing area of software.

In an embodiment of the present disclosure, after obtaining alarm information, the terminal of the initiating user presents a warning prompt control in the predetermined information pushing area, and the warning information is configured for instructing the initiating user to complete a predetermined event within a predetermined time limit. Exemplarily, the predetermined information pushing area is the intra-station information pushing area of software. After the initiating user clicks the warning prompt control, in response to a triggering operation on the warning prompt control, as shown in FIG. 15, the information collection interface 1503 is presented, so that the initiating user copies a delivery address of a target user by clicking the information collection control 1501 and processes same in time.

It can be seen from the foregoing description that, a warning prompt control is presented in the predetermined information pushing area, so as to prompt an initiating user to timely transmit a product of the resource random allocation event.

Referring to FIG. 16, FIG. 16 is a schematic flowchart three of a method for displaying interaction information according to an embodiment of the present disclosure. In order to remind in time that a predetermined interaction event is successfully participated in and a target user allocated to a product can upload a delivery address in time, a background server may transmit reminding information to all target users as well as an initiating user when a list of all target users is determined for the predetermined interaction event. In this embodiment, the process of transmitting reminding information to all target users and the initiating user is described in detail, and the specific steps include:

S1601: presenting pushing information, and presenting a predetermined information pushing control in a predetermined information pushing area according to a first predetermined time point, wherein the pushing information is configured for indicating a result of a current user participating in the predetermined interaction event.

In this embodiment, the first predetermined time point is a time point when the background server determines the result of the predetermined interaction event. Exemplarily, after a list of all the target users who have obtained the products are determined, a pushing message indicating a result of the current user participating in the predetermined interaction event is generated, and the pushing message is transmitted to all the target users to remind the target users to fill in the delivery address in time, and the pushing message is transmitted to the initiating user to remind the initiating user to send out the products in time.

For example, it is determined that the current user is not an initiating user of a predetermined interaction event, and a predetermined information pushing control is presented in a predetermined information pushing area according to a first predetermined time point; and/or it is determined that the current user is the initiating user of the predetermined interaction event, and a time limit prompt control is presented in the predetermined information pushing area according to a second predetermined time node. The predetermined information pushing control is an intra-station information prompt control of software for displaying a pushing message, and the time limit prompt control is configured for prompting an initiating user to perform timely processing within a set time limit. Specifically, the second predetermined time point is within a period of time after the list of target users is determined, for example, 14 days after the list of target users is determined.

Exemplarily, before 24 hours after the end time of filling the delivery address set by the initiating user, if any target user has not filled the delivery address, a predetermined information pushing control is presented in the predetermined information pushing area of the target user, so as to prompt that the delivery address shall be filled in time. Exemplarily, after a delivery address filled in by any target user is obtained, a time limit prompt control is presented to an initiating user in a predetermined information pushing area within 48 hours after the address is filled in.

S1602: in response to a triggering operation on the predetermined information pushing control, displaying the result of the predetermined interaction event, wherein the result of the predetermined interaction event comprises relevant information of at least one target user determined from predetermined state users.

In this embodiment, in response to a triggering operation on a predetermined information pushing control, interaction state information of a current user is obtained; a presentation mode for the information processing control is determined based on the interaction state information; and the information processing control is displayed. Specifically, after a target user or an initiating user clicks the predetermined information pushing control, steps such as displaying a list of successful participants, inputting delivery addresses, and viewing the delivery addresses are executed, and the details of the executed steps are consistent with the technical solution and effect described in S804 in the embodiment of FIG. 8, which are not described herein again.

It can be seen from the described description that by presenting a predetermined information pushing control in a predetermined information pushing area, a target user is prompted to fill in a delivery address in time, or an initiating user is prompted to send out a product to the target user in time, so that the participation effect of a resource random allocation event is improved, and the user experience is improved.

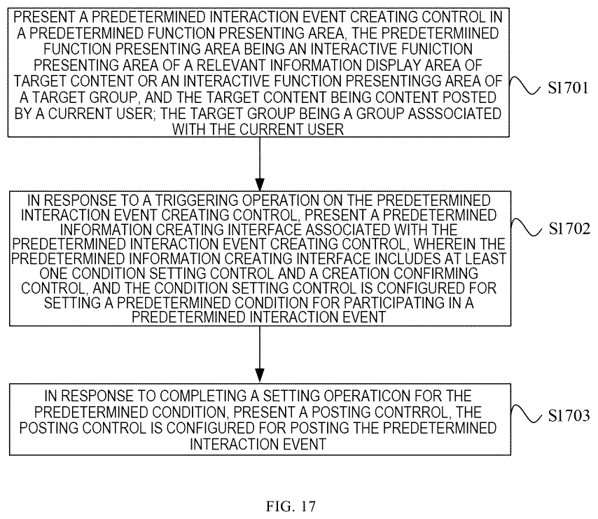

Referring to FIG. 17, FIG. 17 is a schematic flowchart four of a method for displaying interaction information according to an embodiment of the present disclosure. A process of creating a predetermined control is described in detail in this embodiment. The method for displaying interaction information includes:

S1701: presenting a predetermined interaction event creating control in a predetermined function presenting area, the predetermined function presenting area being an interactive function presenting area of a relevant information display area of target content or an interactive function presenting area of a target group, and the target content being content posted by a current user; the target group being a group associated with the current user.

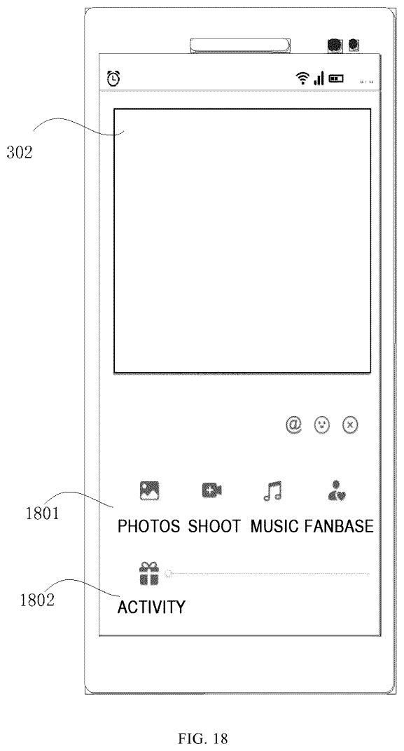

For example, the predetermined function presenting area is an interactive function presenting area of a relevant information display area of target content or an interactive function presenting area of a target group, where the target content is content posted by a current user; the target group is a group associated with the current user. As shown in FIG. 18, a predetermined interaction event creating control 1802 is presented within the interactive function presenting area 1801 of the relevant information display area of the shared target content 302. For example, a name of a button corresponding to the predetermined interaction event creating control 1802 is “Activity”.

S1702: in response to a triggering operation on the predetermined interaction event creating control, presenting a predetermined information creating interface associated with the predetermined interaction event creating control, wherein the predetermined information creating interface comprises at least one condition setting control and a creation confirming control, and the condition setting control is configured for setting a predetermined condition for participating in a predetermined interaction event.

In an embodiment of the present disclosure, in order to improve the effect of a predetermined interaction event, a predetermined interaction information creation condition may be set. Specifically, the predetermined interaction information creation condition includes the number of fans, and it may also limit that only one resource sharing event is allowed to be initiated within the same time. If the user is determined due to other reasons by the system as being prohibited from initiating a resource sharing event using the current account, and when the user clicks the predetermined information creating control, the user is prompted that he/she is not allowed to initiate a resource sharing activity.

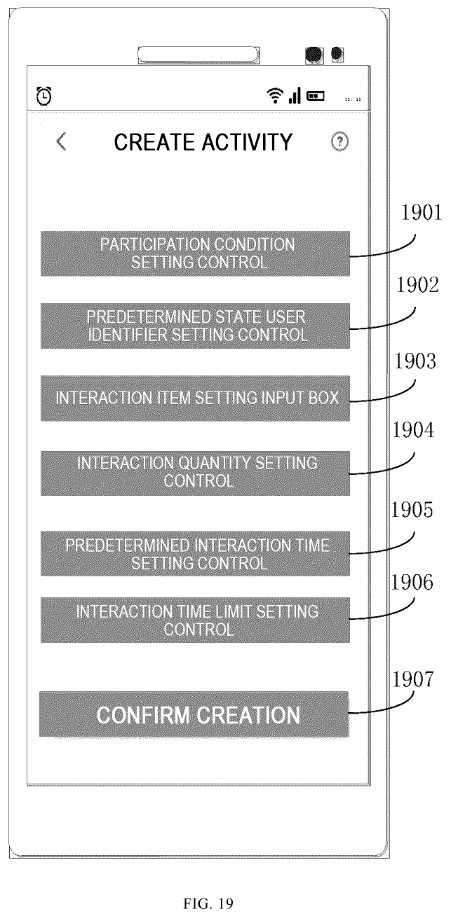

In one embodiment of the present disclosure, as shown in FIG. 19, the condition setting control includes at least one of a participation condition setting control 1901, a predetermined state user identifier setting control 1902, an interaction item setting input box control 1903, an interaction quantity setting control 1904, a predetermined interaction time setting control 1905 and an interaction time limit setting control 1906. Specifically, the button corresponding to the creation control 1907 is configured to confirm creation. Exemplarily, the interaction item setting input box control 1903 may be configured to input product names and product values corresponding to the allocated resources. The interaction quantity setting control 1904 is configured to setting the number of people who participate successfully, and a corresponding number may be selected by clicking a number setting button of the interaction quantity setting control 1904, The predetermined interaction time setting control 1905 is configured to set a time point for determining a list of target users, and the interaction time limit setting control 1906 is configured for setting a time point for ending an activity. By clicking the predetermined interaction time setting control 1905 and the interaction time setting control 1906, a corresponding time setting page may be jumped to, and then predetermined interaction time and an interaction time limit are set.

For example, in response to a triggering operation on the predetermined state user identifier setting control 1902, an account interaction setting interface associated with the predetermined state user identifier setting control 1902 is presented, where the account interaction setting interface includes at least one account interaction setting control. Specifically, the user of the predetermined state user identifier setting control 1902 sets the user characteristic for the users participating in the resource allocation event, i.e., by clicking the predetermined state user identifier setting control 1902, the account interaction setting interface is skipped to, and a specific identifier is determined for users satisfying the set fans range, so as to set the identifier of users who participate in the resource allocation event. Specifically, the account interaction setting control is at least one of an account following condition selecting control, an account activity selecting control and an account level selecting control. At least one piece of interaction setting information is obtained in response to a triggering operation on at least one account interaction setting control in an account interaction setting interface. Exemplarily, the interaction setting control is a following time limit condition setting control, an activity requirement setting control and a fun group rank setting control.

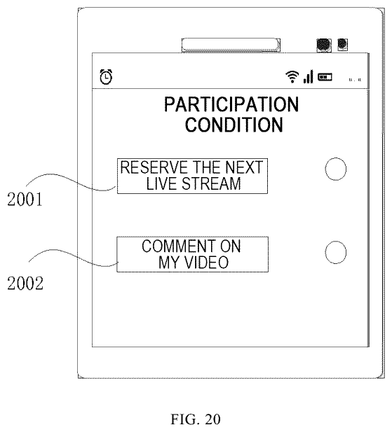

In one embodiment of the present disclosure, the participation condition setting control 1901 is a reservation activity condition setting control and/or a comment target video setting control. Exemplarily, in response to a triggering operation on the participation condition setting control 1901, a participation condition setting interface associated with the participation condition setting control 1901 is presented, and the participation condition setting interface includes at least one participation condition setting control 1901. In response to a triggering operation on at least one participation condition setting control 1901 in the participation condition setting interface, at least one piece of interaction setting information is obtained. Exemplarily, after a button of the participation condition setting control 1901 is selected, the participation condition setting interface is jumped to, where the participation condition setting interface includes at least one selection button. As shown in FIG. 20, for example, the title of the participation condition setting interface is a participation condition, the participation condition setting control includes a Reserve next live livestream control 2001 and a comment My video control 2002, and the user may select the Reserve next live livestream control 2001 or the comment My video control 2002 to satisfy the condition for the participants.

S1703: in response to completing a setting operation for the predetermined condition, presenting a posting control, the posting control is configured for posting the predetermined interaction event.

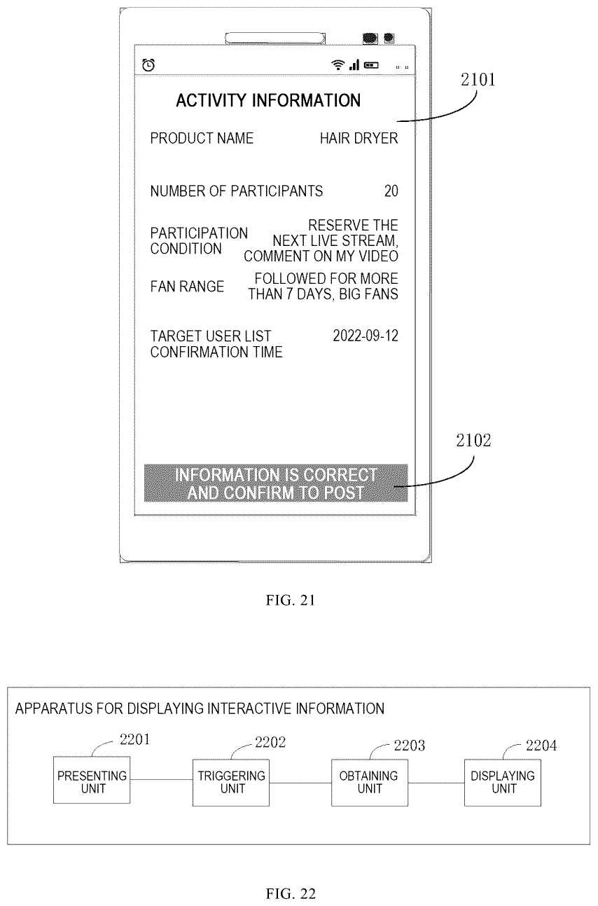

In this embodiment, after the user sets all the parameters and conditions in the predetermined information creating interface, when the user selects a creation confirming control in the predetermined information creating interface, all the interaction setting information set by all the condition setting controls is obtained. Furthermore, when the user selects the creation confirming control on the predetermined information creating interface, the activity information confirmation presenting page is jumped to. Exemplarily, the activity information confirmation presenting page is shown in FIG. 21. Specifically, the title of the activity information confirmation presenting page 2101 is activity information, and all interaction setting information set by all the condition setting controls is presented in the activity information confirmation presenting page 2101. A posting control 2102 for posting a resource random allocation event is also provided beneath the activity information confirmation presenting page 2101. Exemplarily, a button of the posting control 2102 is “Information is correct, and confirm to post”. Exemplarily, introduction information of a resource random allocation event generated based on all interaction setting information is further included at the bottom of the activity information confirmation presenting page 2101, so as to conveniently confirm information in time.

It can be seen from the above description that, by providing a predetermined interaction event creating control in a predetermined function presenting area of target content, a user can create a resource random allocation event while sharing the target content, thereby improving the flow of a user initiating a predetermined interaction event and improving the experience of the user in using software.

Corresponding to the method for displaying interaction information in the foregoing embodiments, FIG. 22 is a structural block diagram of a display apparatus for interaction information according to an embodiment of the present disclosure. For ease of description, only parts related to the embodiments of the present disclosure are shown. Referring to FIG. 22, the display apparatus for interaction information includes a presenting unit 2201, a triggering unit 2202, an obtaining unit 2203, and a displaying unit 2204.

Herein, the presenting unit 2201 is configured to present a predetermined control within a relevant information display area of target content or a target group;
the triggering unit 2202 is configured to trigger, in response to a triggering operation of the predetermined control, to determine whether a current user satisfies a predetermined condition, and determine the current user satisfying the predetermined condition as a predetermined state user, the predetermined state user being a user participating in a predetermined interaction event;
the obtaining unit 2203 is configured to obtain state information based on the triggering operation, the state information comprising information about whether the current user satisfies the predetermined condition and/or information about whether the current user is the predetermined state user;
the displaying unit 2204 is configured to display interaction information based on the state information, the interaction information being displayed based on the state information.

The apparatus provided in this embodiment may be used to execute the technical solutions of the foregoing method embodiments, and implementation principles and technical effects of the apparatus are similar, which will not be repeatedly described herein in this embodiment.

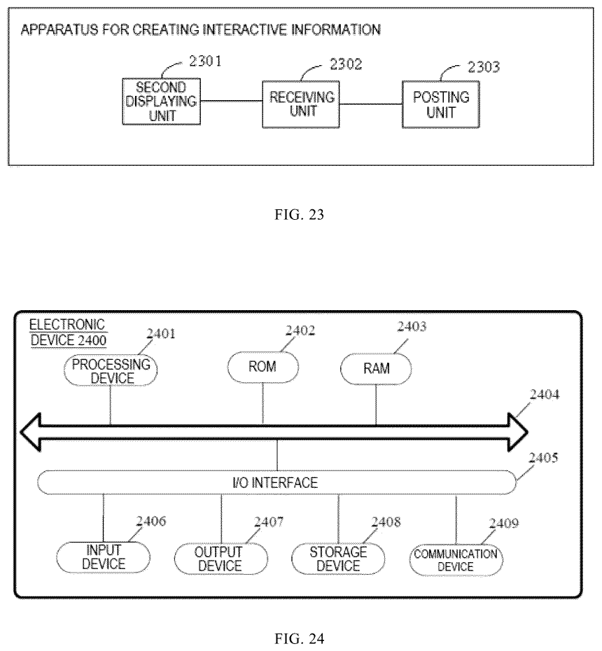

Corresponding to the method for creating interaction information in the foregoing embodiments, FIG. 23 is a structural block diagram of a creation apparatus for interaction information according to an embodiment of the present disclosure. For ease of description, only parts related to the embodiments of the present disclosure are shown. Referring to FIG. 23, the apparatus includes: a presenting unit 2301, a triggering unit 2302, and a posting unit 2303.

Herein, the display unit 2301 is configured to present a predetermined interaction event creating control in a predetermined function presenting area, the predetermined function presenting area being an interactive function presenting area of a relevant information display area of target content or an interactive function presenting area of a target group, and the target content being content posted by a current user; the target group being a group associated with the current user;
the triggering unit 2302 is configured to present, in response to a triggering operation on the predetermined interaction event creating control, a predetermined information creating interface associated with the predetermined interaction event creating control, wherein the predetermined information creating interface comprises at least one condition setting control and a creation confirming control, and the condition setting control is configured for setting a predetermined condition for participating in a predetermined interaction event;
the posting unit 2303 is configured to present a posting control in response to completing a setting operation for the predetermined condition, wherein the posting control is configured for posting the predetermined interaction event.

The apparatus provided in this embodiment may be used to execute the technical solutions of the foregoing method embodiments, and implementation principles and technical effects of the apparatus are similar, which will not be repeatedly described herein in this embodiment.

In order to realize the described embodiments, the embodiments of the present disclosure further provide an electronic device.

Referring to FIG. 24, it is a structural schematic diagram of an electronic device 2400 suitable for implementing the embodiment of the present disclosure, the electronic device 2400 may be a terminal or a server. The terminal device in the embodiment of the present disclosure may include but is not limited to mobile terminals such as mobile phones, laptops, digital broadcast receivers, Personal Digital Assistants (PDAs), tablet computers (PAD for short), portable multimedia players (PMP for short), car-mounted terminals (such as car navigation terminals), etc. and fixed terminals such as digital televisions (TV), desktop computers, etc. The electronic device shown in FIG. 24 is only an example and should not bring any limitation on the functionality and scope of use of the embodiment of the present disclosure.

As shown in FIG. 24, the electronic device 2400 may include a processing device (such as a central processing unit, graphics processing unit, etc.) 2401, which may perform various appropriate actions and processes based on programs stored in Read-Only Memory (ROM for short) 502 or loaded from storage device 2408 into Random Access Memory (RAM for short) 2403. In the RAM 2403, various programs and data necessary for the operation of the electronic device 2400 are also stored. The processing device 2401, ROM 2402, and RAM 2403 are connected to each other through a bus 2404. An Input/Output (I/O for short) interface 2405 is also connected to the bus 2404.

Typically, the following devices can be connected to I/O interface 2405: input devices 2406 including, for example, touch screens, touchpads, keyboards, mice, cameras, microphones, accelerometers, gyroscopes, etc.; output devices 2407 including liquid crystal displays (LCD for short), speakers, vibrators, etc.; storage devices 2408 including magnetic tapes, hard disks, etc.; and a communication device 2409. The communication device 2409 may allow the electronic device 2400 to communicate with other devices wirelessly or wirelessly to exchange data. Although FIG. 24 shows an electronic device 2400 with a plurality of devices, it shall be understood that it is not required to implement or have all of the devices shown. More or fewer devices can be implemented or provided instead.

In particular, according to embodiments of the present disclosure, the process described above with reference to the flowchart can be implemented as a computer software program. For example, an embodiment of the present disclosure includes a computer program product that includes a computer program carried on a computer-readable medium, where the computer program includes program code for performing the method shown in the flowchart. In such an embodiment, the computer program can be downloaded and installed from a network through the communication device 2409, or installed from the storage device 2408, or installed from the ROM 2402. When the computer program is executed by the processing device 2401, the above functions defined in the method of the embodiment of the present disclosure are performed.

It should be noted that the computer-readable medium described above can be a computer-readable signal medium or a computer-readable storage medium, or any combination thereof. The computer-readable storage medium can be, for example, but not limited to, an electrical, magnetic, optical, electromagnetic, infrared, or semiconductor system, apparatus, or device, or any combination thereof. Specific examples of computer-readable storage media may include but are not limited to: an electrical connection with one or more wires, a portable computer disk, a hard disk, RAM, ROM, an erasable programmable read-only memory (EPROM for short) or flash memory, an optical fiber, a portable compact disk read-only memory (CD-ROM for short), an optical storage device, a magnetic storage device, or any suitable combination thereof. In the present disclosure, a computer-readable storage medium may be any tangible medium containing or storing a program that can be used by an instruction execution system, apparatus, or device, or can be used in combination with an instruction execution system, apparatus, or device. In the present disclosure, a computer-readable signal medium can include a data signal propagated in baseband or as part of a carrier wave, which carries computer-readable program code therein. Such propagated data signals may take many forms, including but not limited to electromagnetic signals, optical signals, or any suitable combination thereof. A computer-readable signal medium may also be any computer-readable medium other than a computer-readable storage medium, which can send, propagate, or transmit programs for use by or in conjunction with instruction execution systems, apparatus, or devices. The program code contained on the computer-readable medium may be transmitted using any suitable medium, including but not limited to: wires, optical cables, radio frequency (RF for short), etc., or any suitable combination thereof.

The computer-readable medium can be included in the electronic device, or it can exist alone without being assembled into the electronic device.

The above-mentioned computer-readable medium carries one or more programs, and when the above-mentioned one or more programs are executed by the electronic device, the electronic device implements methods as shown in the above embodiments.

Computer program codes for performing the operations of the present disclosure may be written in one or more programming languages or a combination thereof, including Object Oriented programming languages-such as Java, Smalltalk, C++, and also conventional procedural programming languages-such as “C” or similar programming languages. The program code may be executed entirely on the user's computer, partially executed on the user's computer, executed as a standalone software package, partially executed on the user's computer and partially on a remote computer, or entirely on a remote computer or server. In the case of involving a remote computer, the remote computer may be any kind of network-including local area network (LAN for short) or wide area network (WAN for short)-connected to the user's computer, or may be connected to an external computer (e.g., through an Internet service provider to connect via the Internet).

The flowcharts and block diagrams in the accompanying drawings illustrate the architecture, functions, and operations of possible implementations of the system, method, and computer program product according to various embodiments of the present disclosure. In this regard, each block in a flowchart or block diagram may represent a module, program segment, or portion of code that contains one or more executable instructions for implementing a specified logical function. It should also be noted that in some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

The units described in the embodiments of the present disclosure may be implemented by means of software or hardware, and the name of the unit does not constitute a limitation on the unit itself in a certain case, for example, a first obtaining unit may also be described as “a unit for obtaining at least two internet protocol addresses”.

The functions described herein above can be performed at least in part by one or more hardware logic components. For example, without limitation, exemplary types of hardware logic components that may be used include: Field Programmable Gate Arrays (FPGA for short), Application Specific Integrated Circuits (ASIC for short), Application Specific Standard Parts (ASSP for short), System on Chip (SOC for short), Complex Programmable Logic Devices (CPLD for short), and so on.

In the context of this disclosure, a machine-readable medium can be a tangible medium that may contain or store programs for use by or in conjunction with instruction execution systems, apparatuses, or devices. A machine-readable medium may be a machine-readable signal medium or a machine-readable storage medium. A machine-readable medium may include, but are not limited to, electronic, magnetic, optical, electromagnetic, infrared, or semiconductor systems, apparatuses, or devices, or any suitable combination thereof. Specific examples of the machine-readable storage medium may include electrical connections based on one or more wires, portable computer disks, hard disks, RAM, ROM, EPROM or flash memory, optical fibers, CD-ROM, optical storage devices, magnetic storage devices, or any suitable combination thereof.

In a first aspect, according to one or more embodiments of the present disclosure, a method for displaying interaction information is provided, including:
presenting a predetermined control within a relevant information display area of target content or a target group;
triggering, in response to a triggering operation on the predetermined control, to determine whether a current user satisfies a predetermined condition, and determining the current user satisfying the predetermined condition as a predetermined state user, the predetermined state user being a user participating in a predetermined interaction event;
obtaining state information based on the triggering operation, the state information comprising information about whether the current user satisfies the predetermined condition and/or information about whether the current user is the predetermined state user; and
displaying interaction information based on the state information, the interaction information being displayed based on the state information.

According to one or more embodiments of the present disclosure, displaying the interaction information based on the state information includes: presenting an interaction interface based on the state information, the interaction interface comprising the interaction information, and the interaction information comprising at least one piece of state presentation information and/or at least one interaction control.

According to one or more embodiments of the present disclosure, the at least one piece of state presentation information comprises first state presentation information and/or second state presentation information, wherein the first state presentation information is configured for indicating whether a user is a predetermined state user, and the second state presentation information is configured for indicating whether a user satisfies a predetermined condition, the predetermined condition includes at least one participation condition, and the participation condition includes whether the user belongs to a predetermined user set.

According to one or more embodiments of the present disclosure, the method further comprises: determining a target presentation mode for the at least one interaction control based on the state information, and presenting the at least one interaction control in a corresponding target presentation mode.

According to one or more embodiments of the present disclosure, the predetermined condition includes at least one participation condition, and determining the target presentation mode for the at least one interaction control based on the state information includes:
in response to determining, based on the state information, that the current user does not satisfy the at least one participation condition in the predetermined condition, determining the target presentation mode as a first presentation mode.

According to one or more embodiments of the present disclosure, the predetermined conditions further include at least one interaction condition, and determining the target presentation mode for the at least one interaction control based on the state information includes: in response to determining, based on the state information, that the current user satisfies all the participation conditions in the predetermined condition, determining the target presentation mode for the at least one interaction control based on the at least one interaction condition.

According to one or more embodiments of the present disclosure, each of the interaction controls corresponds to one interaction condition, and determining the target presentation mode for the at least one interaction control based on the at least one interaction condition includes: in response to determining, based on the state information, that the current user satisfies a first interaction condition in the predetermined condition, determining a target presentation mode for a first interaction control corresponding to the first interaction condition as a second presentation mode.

According to one or more embodiments of the present disclosure, determining the target presentation mode for the at least one interaction control based on the at least one interaction condition further includes: in response to determining, based on the state information, that the current user does not satisfy a second interaction condition in the predetermined condition, determining the target presentation mode for a second interaction control corresponding to the second interaction condition as a third presentation mode.

According to one or more embodiments of the present disclosure, the method further includes: in a case that the target presentation mode for the second interaction control is the third presentation mode, in response to a triggering operation on the second interaction control, displaying an interaction page associated with the second interaction condition.

According to one or more embodiments of the present disclosure, the interaction page includes at least one third interaction control, and the third interaction control is configured for performing an interaction operation of a predetermined type corresponding to the second interaction control.

According to one or more embodiments of the present disclosure, the at least one piece of state presentation information further includes third state presentation information, the predetermined condition further includes a predetermined time limit condition, and the third state presentation information is further configured for indicating whether a triggering operation on the predetermined control satisfies the predetermined time limit condition.

According to one or more embodiments of the present disclosure, determining the target presentation mode for the at least one interaction control based on the at least one interaction condition further includes: in response to determining, based on the state information, that the triggering operation on the predetermined control does not satisfy the predetermined time limit condition, determining a target presentation mode for a fourth interaction control corresponding to the predetermined time limit condition as a fourth presentation mode.

According to one or more embodiments of the present disclosure, the method further includes: presenting a predetermined associated control in an associated display area of the relevant information display area; and in response to a triggering operation on the predetermined associated control, displaying a result of the predetermined interaction event, the result of the predetermined interaction event comprising relevant information of at least one target user determined from predetermined state users.

According to one or more embodiments of the present disclosure, the method further comprises: in response to a triggering operation of the predetermined association control, acquiring interaction state information about a current user, and determining a display mode of an information processing control based on the interaction state information, wherein the interaction state information is used for indicating whether the user satisfies a predetermined user condition; and displaying the information processing control.

According to one or more embodiments of the present disclosure, the predetermined user condition comprises a target user condition, the information processing control includes an information input control, and determining the presentation mode for the information processing control based on the interaction state information includes: if it is determined, based on the interaction state information, that the current user satisfies the target user condition, presenting an information input control; and in response to a triggering operation on the information input control, presenting an information input interface, wherein the information input control is configured for being provided to the current user satisfying the target user condition for information input.

According to one or more embodiments of the present disclosure, the predetermined user condition includes an initiating user condition, the information processing control comprises an information querying control, and determining the presentation mode for the information processing control based on the interaction state information includes: determining, based on the interaction state information, that the current user satisfies the initiating user condition, and presenting the information querying control; and in response to a triggering operation on the information querying control, presenting an information collection interface, the information collection interface including at least one of the following: association information corresponding to the at least one target user, an information collection control corresponding to the at least one target user and an information interactive control corresponding to the at least one target user.

According to one or more embodiments of the present disclosure, the method further includes, after presenting the information collection interface: in response to a triggering operation on the information collection control corresponding to the target user, obtaining association information corresponding to the target user; and/or, in response to a triggering operation on the information interactive control corresponding to the target user, presenting an information interactive interface corresponding to the target user.

According to one or more embodiments of the present disclosure, the method further includes: presenting pushing information, and presenting a predetermined information pushing control in a predetermined information pushing area according to a first predetermined time point, wherein the pushing information is configured for indicating a result of a current user participating in the predetermined interaction event; and in response to a triggering operation on the predetermined information pushing control, displaying the result of the predetermined interaction event, wherein the result of the predetermined interaction event comprises relevant information of at least one target user determined from predetermined state users.

According to one or more embodiments of the present disclosure, the method further includes: in response to the triggering operation on the predetermined information pushing control, obtaining interaction state information of the current user; determining a presentation mode for an information processing control based on the interaction state information; and displaying the information processing control.

According to one or more embodiments of the present disclosure, the presenting push information comprises: determining that the current user is not an initiating user of the predetermined interaction event, and presenting the predetermined information pushing control in the predetermined information pushing area according to the first predetermined time point; and/or determining that the current user is the initiating user of the predetermined interaction event, and presenting a time limit prompting control in the predetermined information pushing area according to a second predetermined time point.

According to one or more embodiments of the present disclosure, the predetermined interaction event is a resource random allocation event.

According to a second aspect, in one or more embodiments of the present disclosure, a method for creating interaction information is provided, including:
presenting a predetermined interaction event creating control in a predetermined function presenting area, the predetermined function presenting area being an interactive function presenting area of a relevant information display area of target content or an interactive function presenting area of a target group, and the target content being content posted by a current user; the target group being a group associated with the current user;
in response to a triggering operation on the predetermined interaction event creating control, presenting a predetermined information creating interface associated with the predetermined interaction event creating control, wherein the predetermined information creating interface comprises at least one condition setting control and a creation confirming control, and the condition setting control is configured for setting a predetermined condition for participating in a predetermined interaction event; and
in response to completing a setting operation for the predetermined condition, presenting a posting control, the posting control is configured for posting the predetermined interaction event.

According to a third aspect, according to one or more embodiments of the present disclosure, an apparatus for displaying interaction information is provided, including:
a presenting unit configured to present a predetermined control within a relevant information display area of target content or a target group;
a triggering unit configured to trigger, in response to a triggering operation of the predetermined control, to determine whether a current user satisfies a predetermined condition, and determine the current user satisfying the predetermined condition as a predetermined state user, the predetermined state user being a user participating in a predetermined interaction event;
an obtaining unit configured to obtain state information based on the triggering operation, the state information comprising information about whether the current user satisfies the predetermined condition and/or information about whether the current user is the predetermined state user; and
a displaying unit configured to display interaction information based on the state information, the interaction information being displayed based on the state information.

According to one or more embodiments of the present disclosure, the displaying unit is specifically configured to present an interaction interface based on the state information, the interaction interface including the interaction information, and the interaction information including at least one piece of state presentation information and/or at least one interaction control.

According to one or more embodiments of the present disclosure, the display apparatus for interaction information further includes an interaction presenting unit, which is specifically configured to determine a target presentation mode for the at least one interaction control based on the state information, and present the at least one interaction control in a corresponding target presentation mode.

According to one or more embodiments of the present disclosure, the predetermined condition includes at least one participation condition, and the interaction presenting unit is further configured to determine the target presentation mode as a first presentation mode, in response to determining, based on the state information, that the current user does not satisfy the at least one participation condition in the predetermined condition.

According to one or more embodiments of the present disclosure, the predetermined condition further includes at least one interaction condition, and the interaction presenting unit is further configured to determine the target presentation mode for the at least one interaction control based on the at least one interaction condition, in response to determining, based on the state information, that the current user satisfies all the participation conditions in the predetermined condition.

According to one or more embodiments of the present disclosure, each of the interaction controls corresponds to one interaction condition; and the interaction presenting unit is further configured to determine a target presentation mode for a first interaction control corresponding to the first interaction condition as a second presentation mode, in response to determining, based on the state information, that the current user satisfies a first interaction condition in the predetermined condition.

According to one or more embodiments of the present disclosure, the interaction presenting unit is further configured to determine the target presentation mode for a second interaction control corresponding to the second interaction condition as a third presentation mode, in response to determining, based on the state information, that the current user does not satisfy a second interaction condition in the predetermined condition.

According to one or more embodiments of the present disclosure, the interaction presenting unit is further configured to display interaction page associated with the second interaction condition in response to a triggering operation on the second interaction control, in a case that the target presentation mode for the second interaction control is the third presentation mode.

According to one or more embodiments of the present disclosure, the interaction presenting unit is further configured to determine a target presentation mode for a fourth interaction control corresponding to the predetermined time limit condition as a fourth presentation mode, in response to determining, based on the state information, that the triggering operation on the predetermined control does not satisfy the predetermined time limit condition.

According to one or more embodiments of the present disclosure, the display apparatus for interaction information further includes a result display unit configured to present a predetermined associated control in an associated display area of the relevant information display area; in response to a triggering operation on the predetermined associated control, display a result of the predetermined interaction event, the result of the predetermined interaction event including relevant information of at least one target user determined from predetermined state users.

According to one or more embodiments of the present disclosure, the display apparatus for interaction information further includes a processing unit configured to, in response to the triggering operation on the predetermined associated control, obtain interaction state information of the current user, and determine a presentation mode for an information processing control based on the interaction state information, wherein the interaction state information is configured for indicating whether a user satisfies a predetermined user condition, and display the information processing control.

According to one or more embodiments of the present disclosure, the processing unit is further configured to present an information input control if it is determined, based on the interaction state information, that the current user satisfies the target user condition; and present an information input interface in response to a triggering operation on the information input control, wherein the information input control is configured for being provided to the current user satisfying the target user condition for information input.

According to one or more embodiments of the present disclosure, the processing unit is further configured to determine, based on the interaction state information, that the current user satisfies the initiating user condition, and present the information querying control; and in response to a triggering operation on the information querying control, present an information collection interface, the information collection interface including at least one of the following: association information corresponding to the at least one target user, an information collection control corresponding to the at least one target user and an information interactive control corresponding to the at least one target user.

According to one or more embodiments of the present disclosure, the display apparatus for interaction information further comprises an obtaining unit configured to obtain association information corresponding to the target user, in response to a triggering operation on the information collection control corresponding to the target user; and/or, in response to a triggering operation on the information interactive control corresponding to the target user, present an information interactive interface corresponding to the target user.

According to one or more embodiments of the present disclosure, the display apparatus for interaction information further includes a presentation pushing unit configured to present pushing information, and present a predetermined information pushing control in a predetermined information pushing area according to a first predetermined time point, wherein the pushing information is configured for indicating a result of a current user participating in the predetermined interaction event; in response to a triggering operation on the predetermined information pushing control, display the result of the predetermined interaction event, wherein the result of the predetermined interaction event includes relevant information of at least one target user determined from predetermined state users.

According to one or more embodiments of the present disclosure, the interaction information display device further comprises a determining unit configured to, in response to the triggering operation on the predetermined information pushing control, obtain interaction state information of the current user; determine a presentation mode for an information processing control based on the interaction state information; and display the information processing control.

In a fourth aspect, according to one or more embodiments of the present disclosure, there is provided a creation apparatus for interaction information, comprising:
a presenting unit configured to present a predetermined interaction event creating control in a predetermined function presenting area, the predetermined function presenting area being an interactive function presenting area of a relevant information display area of target content or an interactive function presenting area of a target group, and the target content being content posted by a current user; the target group being a group associated with the current user;
a triggering unit configured to present, in response to a triggering operation on the predetermined interaction event creating control, a predetermined information creating interface associated with the predetermined interaction event creating control, wherein the predetermined information creating interface comprises at least one condition setting control and a creation confirming control, and the condition setting control is configured for setting a predetermined condition for participating in a predetermined interaction event; and
a posting unit configured to present a posting control in response to completing a setting operation for the predetermined condition, wherein the posting control is configured for posting the predetermined interaction event.

In a fifth aspect, according to one or more embodiments of the present disclosure, there is provided an electronic device, including: at least one processor and a memory;
the memory stores a computer execution instruction;
the at least one processor executes the computer execution instruction stored in the memory, so that the processor implements a method for displaying interaction information according to the first aspect and various possible designs of the first aspect, or the method for creating interaction information according to the second aspect and various possible designs of the second aspect.

In a sixth aspect, according to one or more embodiments of the present disclosure, there is provided a computer readable storage medium, The computer readable storage medium stores a computer execution instruction. When executing the computer execution instruction, a processor implements a method for displaying interaction information according to the first aspect and various possible designs of the first aspect, or a method for creating interaction information according to various possible designs of the second aspect and the second aspect.

In a seventh aspect, according to one or more embodiments of the present disclosure, a computer program product is provided, including a computer program. When being executed by a processor, the computer program implements the method for displaying interaction information according to the foregoing first aspect and various possible designs of the first aspect, or the method for creating interaction information according to the foregoing second aspect and various possible designs of the second aspect.

The above description is only embodiments of this disclosure and an explanation of the technical principles used. Those skilled in the art should understand that the scope of the disclosure involved in this disclosure is not limited to technical solutions composed of specific combinations of the above technical features, but should also covers other technical solutions formed by arbitrary combinations of the above technical features or their equivalent features without departing from the above disclosure concept. For example, technical solutions formed by replacing the above features with (but not limited to) technical features with similar functions disclosed in this disclosure.

In addition, although a plurality of operations are depicted in a specific order, this should not be understood as requiring these operations to be performed in the specific order shown or in a sequential order. In certain environments, multitasking and parallel processing may be advantageous. Similarly, although a plurality of implementation details are included in the above discussion, these should not be construed as limiting the scope of the present disclosure. Some features described in the context of individual embodiments can also be implemented in combination in a single embodiment. Conversely, a plurality of features described in the context of a single embodiment can also be implemented in a plurality of embodiments separately or in any suitable sub-combination.

Although the subject matter has been described in language specific to structural features and/or methodological logical actions, it should be understood that the subject matter defined in the appended claims is not necessarily limited to the specific features or actions described above. On the contrary, the specific features and actions described above are merely example forms of implementing the claims.

1. A method for displaying interaction information, comprising:
presenting a predetermined control within a relevant information display area of target content or a target group;
in response to a triggering operation on the predetermined control,
obtaining state information based on the triggering operation, the state information comprising information about whether a current user satisfies a predetermined condition and/or information about whether the current user is the predetermined state user, the predetermined state user being a user participating in a predetermined interaction event; and
displaying interaction information based on the state information, the interaction information being displayed based on the state information.

2. The method for displaying of claim 1, wherein displaying the interaction information based on the state information comprises:
presenting an interaction interface based on the state information, the interaction interface comprising the interaction information, and the interaction information comprising at least one piece of state presentation information and/or at least one interaction control.

3. The method for displaying of claim 2, wherein the at least one piece of state presentation information comprises first state presentation information and/or second state presentation information, wherein the first state presentation information is configured for indicating whether a user is a predetermined state user, and the second state presentation information is configured for indicating whether a user satisfies a predetermined condition, the predetermined condition comprises at least one participation condition, and the participation condition comprises whether the user belongs to a predetermined user set.

4. The method for displaying of claim 2, wherein the method further comprises:
determining a target presentation mode for the at least one interaction control based on the state information, and presenting the at least one interaction control in a corresponding target presentation mode.

5. The method for displaying of claim 4, wherein the predetermined condition comprises at least one participation condition, and determining the target presentation mode for the at least one interaction control based on the state information comprises:
in response to determining, based on the state information, that the current user does not satisfy the at least one participation condition in the predetermined condition, determining the target presentation mode as a first presentation mode.

6. The method for displaying of claim 4, wherein the predetermined condition further comprises at least one interaction condition, and determining the target presentation mode for the at least one interaction control based on the state information comprises:
in response to determining, based on the state information, that the current user satisfies all the participation conditions in the predetermined condition, determining the target presentation mode for the at least one interaction control based on the at least one interaction condition.

7. The method for displaying of claim 6, wherein each of the interaction controls corresponds to one interaction condition, and determining the target presentation mode for the at least one interaction control based on the at least one interaction condition comprises:
in response to determining, based on the state information, that the current user satisfies a first interaction condition in the predetermined condition, determining a target presentation mode for a first interaction control corresponding to the first interaction condition as a second presentation mode.

8. The method for displaying of claim 6, wherein determining the target presentation mode for the at least one interaction control based on the at least one interaction condition further comprises:
in response to determining, based on the state information, that the current user does not satisfy a second interaction condition in the predetermined condition, determining the target presentation mode for a second interaction control corresponding to the second interaction condition as a third presentation mode.

9. The method for displaying of claim 8, further comprising:
in response to the target presentation mode for the second interaction control being the third presentation mode, in response to a triggering operation on the second interaction control, displaying an interaction page associated with the second interaction condition.

10. The method for displaying of claim 9, wherein the interaction page comprises at least one third interaction control, and the third interaction control is configured for performing an interaction operation of a predetermined type corresponding to the second interaction control.

11. The method for displaying of claim 6, wherein the at least one piece of state presentation information further comprises third state presentation information, the predetermined condition further comprises a predetermined time limit condition, and the third state presentation information is further configured for indicating whether a triggering operation on the predetermined control satisfies the predetermined time limit condition.

12. The method for displaying of claim 11, wherein determining the target presentation mode for the at least one interaction control based on the at least one interaction condition further comprises:
in response to determining, based on the state information, that the triggering operation on the predetermined control does not satisfy the predetermined time limit condition, determining a target presentation mode for a fourth interaction control corresponding to the predetermined time limit condition as a fourth presentation mode.

13. The method for displaying of claim 1, further comprising:
presenting a predetermined associated control in an associated display area of the relevant information display area; and
in response to a triggering operation on the predetermined associated control, displaying a result of the predetermined interaction event, the result of the predetermined interaction event comprising relevant information of at least one target user determined from predetermined state users.

14. The method for displaying of claim 13, further comprising:
in response to the triggering operation on the predetermined associated control, obtaining interaction state information of the current user, and determining a presentation mode for an information processing control based on the interaction state information, wherein the interaction state information is configured for indicating whether a user satisfies a predetermined user condition; and
displaying the information processing control.

15. The method for displaying of claim 14, wherein the predetermined user condition comprises a target user condition, the information processing control comprises an information input control, and determining the presentation mode for the information processing control based on the interaction state information comprises:
in response to a determination, based on the interaction state information, that the current user satisfies the target user condition, presenting an information input control; and
in response to a triggering operation on the information input control, presenting an information input interface, the information input control being provided to the current user satisfying the target user condition for information input.

16. The method for displaying of claim 13, wherein the predetermined user condition comprises an initiating user condition, the information processing control comprises an information querying control, and determining the presentation mode for the information processing control based on the interaction state information comprises:
determining, based on the interaction state information, that the current user satisfies the initiating user condition, and presenting the information querying control; and
in response to a triggering operation on the information querying control, presenting an information collection interface, the information collection interface comprising at least one of: association information corresponding to the at least one target user, an information collection control corresponding to the at least one target user and an information interactive control corresponding to the at least one target user.

17. The method for displaying of claim 16, wherein the method further comprises, after presenting the information collection interface:
in response to a triggering operation on the information collection control corresponding to the target user, obtaining association information corresponding to the target user; and/or,
in response to a triggering operation on the information interactive control corresponding to the target user, presenting an information interactive interface corresponding to the target user.

18. The method for displaying of claim 1, further comprising:
presenting pushing information, and presenting a predetermined information pushing control in a predetermined information pushing area according to a first predetermined time point, the pushing information being configured for indicating a result of a current user participating in the predetermined interaction event; and
in response to a triggering operation on the predetermined information pushing control, displaying the result of the predetermined interaction event, the result of the predetermined interaction event comprising relevant information of at least one target user determined from predetermined state users.

19-21. (canceled)

22. A method for creating interaction information, comprising:
presenting a predetermined interaction event creating control in a predetermined function presenting area, the predetermined function presenting area being an interactive function presenting area of a relevant information display area of target content or an interactive function presenting area of a target group, and the target content being content posted by a current user; the target group being a group associated with the current user;
in response to a triggering operation on the predetermined interaction event creating control, presenting a predetermined information creating interface associated with the predetermined interaction event creating control, wherein the predetermined information creating interface comprises at least one condition setting control and a creation confirming control, and the condition setting control is configured for setting a predetermined condition for participating in a predetermined interaction event; and
in response to completing a setting operation for the predetermined condition, presenting a posting control, the posting control being configured for posting the predetermined interaction event.

23-24. (canceled)

25. An electronic device, comprising: a processor and a memory;
the memory stores a computer execution instruction;
the processor executes the computer execution instruction stored in the memory, so that the processor implements a method for displaying interaction information, comprising:
presenting a predetermined control within a relevant information display area of target content or a target group;
in response to a triggering operation on the predetermined control, obtaining state information based on the triggering operation, the state information comprising information about whether a current user satisfies a predetermined condition and/or information about whether the current user is the predetermined state user, the predetermined state user being a user participating in a predetermined interaction event; and
displaying interaction information based on the state information, the interaction information being displayed based on the state information.

26-27. (canceled)
